(19) United States
(12) Patent Application Publication
(10) Pub. No.: US 2013/0071667 A1
(43) Pub. Date: Mar. 21, 2013

(54) SEAL LAQUER

(71) Applicants: Thomas Kesmarszky, Weiherhammer (DE); Stefan Frischmann, Vohenstrauss (DE)

(72) Inventors: Thomas Kesmarszky, Weiherhammer (DE); Dirk Kaczmarek, Weiden (DE); Stefan Frischmann, Vohenstrauss (DE)

(21) Appl. No.: 13/599,282

(22) Filed: Aug. 30, 2012

(30) Foreign Application Priority Data
Aug. 31, 2011 (DE) 10 2011 081 873.1

(51) Int. Cl. C09D 169/00; C08K 5/06; B05D 5/00; C09D 125/10; B32B 27/36; B32B 27/32

(52) U.S. Cl. 428/412; 428/523; 427/385.5; 524/577; 524/366; 524/612; 524/515; 524/502; 524/537

(57) ABSTRACT

Seal lacquer, which is liquid and at least 50% UV-permeable under normal conditions.

### CROSS-REFERENCES TO RELATED APPLICATIONS

This application claims the priority of German Patent Application, Serial No. 10 2011 081 873.1, filed Aug. 31, 2011, the content of which is incorporated herein by reference in its entirety as if fully set forth herein.

### FIELD OF THE INVENTION

The invention relates to a method for producing seal lacquer and to a seal lacquer. The invention furthermore relates to a method for producing a sealing layer, a sealing layer and a packaging.

### BACKGROUND OF THE INVENTION

A plastics material film may be used, for example, to close a packaging. The sealing seams between the cover film and the remaining packaging are decisive for the function of the packaging here. One parameter for characterising a sealing seam is the sealing seam strength. Basically, a distinction is made here between peel seals (removable seals) with a low sealing seam strength and rigid seals with a high sealing seam strength.

The packaging has to have further physical and chemical properties, depending on need.

### SUMMARY OF THE INVENTION

The invention is based on the object of improving a method for producing seal lacquer.

An object of the invention is achieved by a method for producing a seal lacquer comprising the following steps:
providing an organic solvent selected from the group of aliphatic, hydrogenated, cyclic and linear or branched hydrocarbons, ketones and cyclic aliphatic or aromatic ethers,
providing at least one sealing means selected from the group of cyclic olefin copolymer (COC) and polycarbonate (PC) and
dissolving the at least one sealing means in the solvent to produce a liquid phase.

The core of the invention consists in dissolving a sealing means selected from the group of cyclic olefin copolymer (COC) and polycarbonate (PC) in an organic solution. The seal lacquer is therefore very easy to produce.

A further object of the invention consists in providing an improved seal lacquer.

This object is achieved by a method for producing a seal lacquer comprising the following steps:
providing an organic solvent selected from the group of aliphatic, hydrogenated, cyclic and linear or branched hydrocarbons, ketones and cyclic aliphatic or aromatic ethers,
providing at least one sealing means selected from the group of cyclic olefin copolymer (COC) and polycarbonate (PC) and
dissolving the at least one sealing means in the solvent to produce a liquid phase
   wherein at least two, in particular a plurality of sealing means dissolved in solvent, are added.

The seal lacquer according to invention is liquid and at least 70% UV-permeable under normal conditions. It is therefore particularly easy to apply. It is also suitable for sterilising the packaging content by means of UV radiation, in particular below 240 nm.

According to one aspect of the invention, the seal lacquer has at least a proportion selected from the group of cyclic olefin copolymer (COC) and polycarbonate (PC).

It may also have a proportion selected from the group of substituted benzenes such as α-methylstyrene, styrene and functional rubbers, in particular styrene-hydrocarbon block copolymers, for example SEBS, SBS, SIBS, SIS.

The seal lacquer may also consist of pure COC.

It may have boundary groups selected from the group of maleic acid modified hydrocarbon resins. As a result, the physical and chemical properties of the seal lacquer, such as, in particular, the adhesive power, can easily be influenced.

The seal lacquer is, in particular, a heat-seal lacquer.

A sealing layer can be produced particularly easily with the seal lacquer according to the invention.

Depending on need, the mechanical properties thereof, in particular the peelability, can be influenced by selecting the drying parameters of the seal lacquer, in particular the drying temperature and/or the drying period and/or the drying pressure.

The sealing layer according to the invention is distinguished by an adjustable sealing seam strength. The sealing seam strength can extend from slightly peelable (“easy-peel”) through peelable (“peel”) to a rigid seal (“no peel”).

The advantages of the packaging according to the invention correspond to those which have already been described above.

The carrier element, on which the sealing layer is applied, is preferably configured as a plastics material film.

It is, in particular, UV-transparent. In particular, it has a degree of transmission of at least 50%, in particular at least 70%, in particular at least 90%, for radiation in the UV range, in particular with wavelengths below 240 nm.

Further advantages and details of the invention emerge from the description of an embodiment.

### BRIEF DESCRIPTION OF THE DRAWINGS

FIG. 1 shows a schematic view of a packaging according to the invention.

FIG. 2 shows a corresponding view of a further embodiment of a packaging.

FIG. 3 shows the dependency of the sealing seam strength of sealing layers of different composition on the temperature of the drying window.

FIG. 4 shows the dependency of the sealing seam strength of different seal lacquers depending on the percentage proportion of COC thereof.

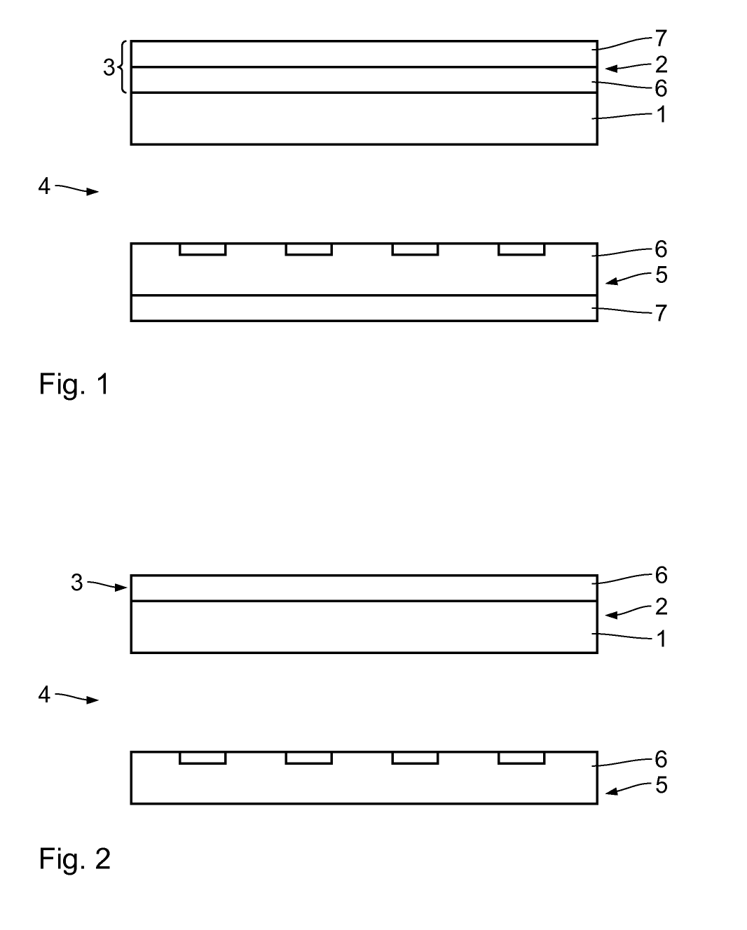

### DESCRIPTION OF THE PREFERRED EMBODIMENT

To produce the seal lacquer 1, a sealing means is dissolved in an organic solvent.

The sealing means is selected from the group of cyclic olefin copolymer (COC) and polycarbonate (PC). It may also have a proportion selected from the group of substituted benzenes such as α-methylstyrene, styrene and functional rubbers, in particular styrene-hydrocarbon block copolymers, for example SEBS, SBS, SIBS, SIS. To produce the sealing means, a dissolving process is provided with the provision of an organic solvent and the addition of resins while stirring to a complete solution. The solutions of the individual resins prepared first can then be mixed in organic solvents while stirring in an addition process. During the dissolving process, a heating of the organic solvent is provided, in particular. The solvent is heated, in particular, to a temperature in the range from 40° C. to 70° C. The addition process in particular takes place at normal temperature. Alternatively, the solutions can also be heated during the addition process to temperatures in the range from 40° C. to 70° C.

Aliphatic, hydrogenated, cyclic and linear or branched hydrocarbons, ketones and cyclic aliphatic or aromatic ethers, for example, serve as suitable solvents.

The sealing means is, in particular, transparent. It is present as a Newton's solution, which, for example, in particular also with shearing, for example during application, exhibits Newton's flow behaviour. A thixotropic or dilatant flow behaviour is ruled out.

Four examples of the composition of the sealing means will be given below by way of example:

### Example 1

| | |
|---|---|
| Solvent: hydrogenated, cyclic hydrocarbon | 90 parts |
| COC resin solid | 10 parts |

### Example 2

| | |
|---|---|
| Solvent: hydrogenated, cyclic hydrocarbon: | 90 parts |
| COC resin solid | 6 parts |
| Mod. SEBS resin solid | 2 parts |
| Hydrocarbon resin solid | 2 parts |

### Example 3

| | |
|---|---|
| COC resin liquid | 70 parts |
| Mod. SEBS resin liquid | 15 parts |
| Hydrocarbon resin liquid | 15 parts |

### Example 4

| | |
|---|---|
| Solvent: cyclic ether | 90 parts |
| PC resin solid | 6 parts |
| Mod. SEBS resin solid | 2 parts |
| Hydrocarbon resin solid | 2 parts |

In order to ensure the high transparency of the sealing means, no further additives were added to the exemplary formulations given above.

The seal lacquer 1 produced in this manner is liquid under normal conditions and at least 50% UV-permeable. UV-permeability is taken to mean here that the lacquer is transparent to electromagnetic radiation in the UV range, in particular to wavelengths of less than 240 nm. The UV-permeability is in particular at least 60%, in particular at least 70%, in particular at least 80%, in particular at least 90%. The seal lacquer 1 is in particular also at least 50%, in particular at least 60%, in particular at least 70%, in particular at least 80%, in particular at least 90% UV-permeable in the physically dry state.

The lacquer has at least a proportion selected from the group of cyclic olefin copolymer (COC) and polycarbonate (PC). It may also have a proportion selected from the group of substituted benzenes such as α-methylstyrene, styrene and functional rubbers, in particular styrene-hydrocarbon block copolymers, for example SEBS, SBS, SIBS, SIS.

It may also consist of pure COC.

The COC has, in particular, boundary groups selected from the group of maleic acid modified hydrocarbon resins. As a result, the mechanical and chemical properties of the seal lacquer 1 can easily be influenced.

To produce a sealing layer 2, the seal lacquer 1 is applied to a carrier element configured as a sealing film 3. The seal lacquer 1 is present here in the liquid phase. The seal lacquer 1 according to the invention adheres to the sealing film 3. The adhesive properties with respect to the sealing film are distinguished in that a very strong adhesive bond is present. An adhesion promoter layer is not required.

A multi-layer film, in particular a composite film, is used, for example, as the sealing film 3. It comprises, for example, a polyamide film 7, in particular made of aliphatic polyamides, in particular of PA6 or a polyvinyl chloride film as well as, in particular, a COC film 6. A monofilm, in particular a COC film 6, may also be used as the sealing film. The material of the sealing film 3 is, in particular, selected from the group of polyvinyl chloride (PVC), polycarbonate (PC), polyoxymethylene (POM), polymethyl methacrylate (PMMA), cyclic olefin copolymer (COC), Barex® and Aclar®.

The sealing film has a thickness in the range from 50 μm to 500 μm, in particular in the range from 100 μm to 150 μm. It is made of a highly transparent material. The sealing film 3 is, in particular, UV-permeable. The UV permeability of the sealing film 3 is, in particular, at least 60%, in particular at least 70%, in particular at least 80%, in particular at least 90%.

After the application of the seal lacquer 1 to the sealing film 3, the lacquer is dried. It was recognised here that by targeted adjustment of the drying conditions, the adhesion of the sealing layer with respect to the sealing film 3 can be changed in a targeted manner. Depending on need, a drying window with temperatures in the range from 80° C. to 160° C., in particular of at least 120° C., is provided to dry the seal lacquer 1. The drying period is in the range from 5 s to 10 s. The drying process is carried out at normal pressure.

It was recognised according to the invention that by targeted adjustment of the formulation, the properties, in particular the sealing seam strength, of the sealing layer can be adjusted. It was possible to show by tensile tests after the sealing that the separation between the sealing film 3 and base film 5 always runs cohesively. An additional adhesion promoter layer is, in particular, not required.

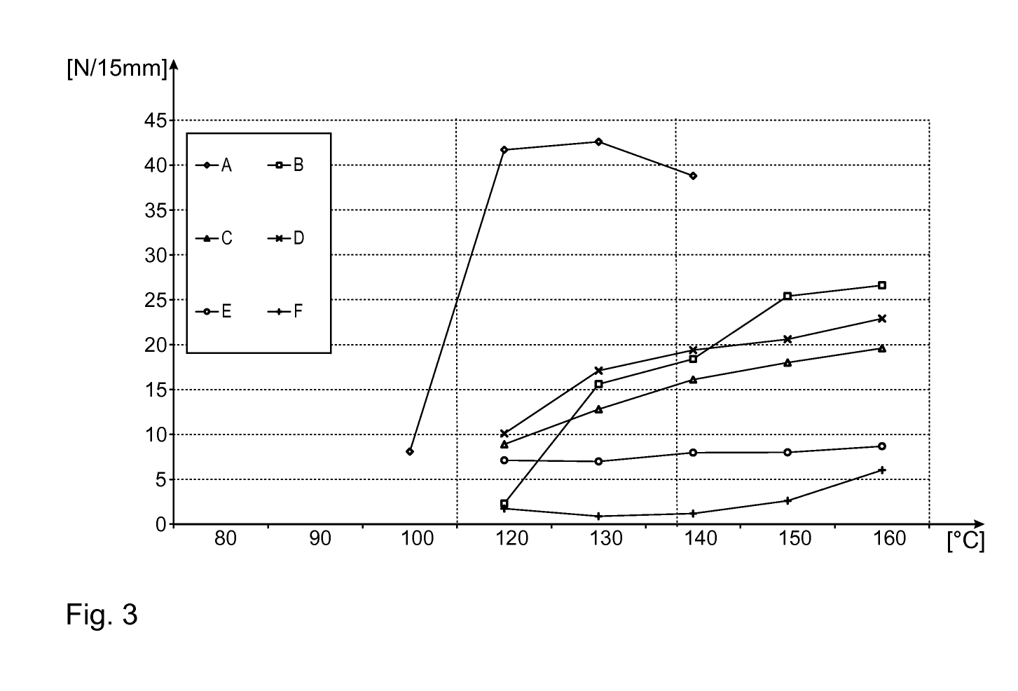

Within the limits given, a higher sealing temperature leads to a higher sealing seam strength. Likewise, a higher sealing pressure leads to a higher sealing seam strength. Sealing profiles for the formulations given above are shown in FIG. 3. The sealing seam strength is plotted here against the sealing temperature. The compositions of the formulations shown in FIG. 3 are summarised in Table 1. They partially correspond to the examples given above.

TABLE 1

| | Solvent: | COC | Modified | |
|---|---|---|---|---|
| | hydrogenated, cyclic | resin | SEBS resin | Hydrocarbon |
| | hydrocarbon | (solid) | (solid) | resin |
| A | 89.69 | 10.31 | 0 | 0 |
| B | 89.69 | 8.25 | 2.06 | 0 |
| C | 89.69 | 7.22 | 3.09 | 0 |
| D | 89.69 | 6.19 | 2.06 | 2.06 |
| E | 89.69 | 5.15 | 3.09 | 2.06 |
| F | 89.69 | 4.12 | 4.12 | 2.06 |

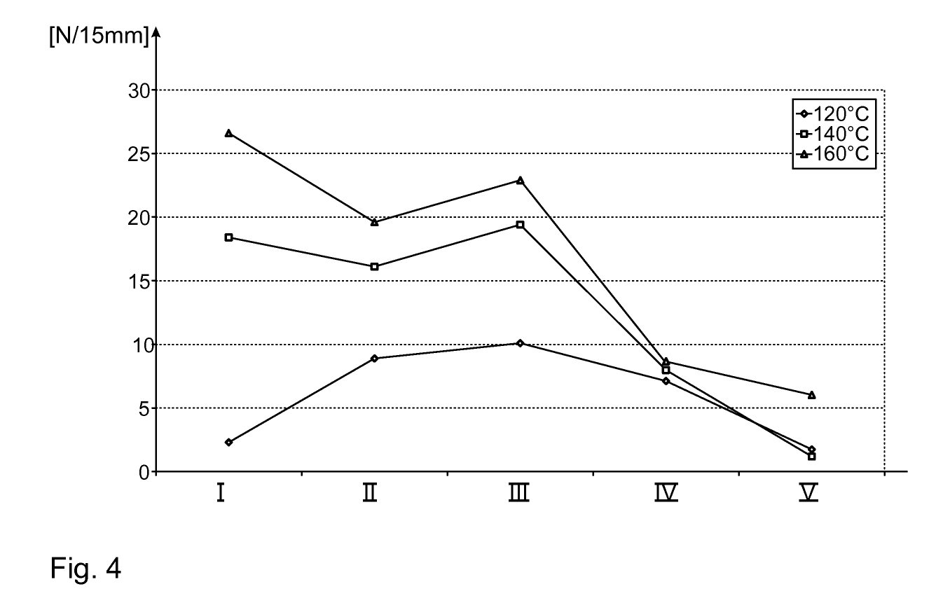

The sealing layer according to the invention is therefore distinguished by an adjustable sealing seam strength. The sealing seam strength of the sealing layer 2 can be adjusted by targeted adjustment of the drying parameters and/or by targeted selection of the proportions of the COC in the seal lacquer 1. The dependency of the sealing seam strength on the percentage proportion of COC in the formulation of the seal lacquer 1 is shown in FIG. 4. The different formulations of the seal lacqueres 1 shown in FIG. 4 are listed in Table 2. Three values of sealing seam strength for drying temperatures of 120° C., 140° C. and 160° C. are shown, in each case, in FIG. 4. These are substantially variations of Example 2 listed above.

TABLE 2

| | Solvent: | COC | Modified | |
|---|---|---|---|---|
| | hydrogenated, cyclic | resin | SEBS resin | Hydrocarbon |
| | hydrocarbon | (solid) | (solid) | resin |
| I | 89.69 | 8.25 | 2.06 | 0 |
| II | 89.69 | 7.22 | 3.09 | 0 |
| III | 89.69 | 6.19 | 2.06 | 2.06 |
| IV | 89.69 | 5.15 | 3.09 | 2.06 |
| V | 89.69 | 4.12 | 4.12 | 2.06 |

The sealing seam strength of the sealing layer 2 according the invention may, in particular, be in the range from 2 N/15 mm to 5 N/15 mm (“easy-peel”) or in the range from 5 N/15 mm to 15 N/15 mm (“peel”) or in the range from 15 N/15 mm to 40 N/15 mm or more (“no peel”).

The sealing layer 2 is, in particular, a mono-layer coating. The sealing layer 2 can be combined with other amorphous plastics materials, for example polycarbonates, polyacrylates and polyesters.

The sealing layer 2 is UV-permeable. The UV-permeability of the sealing layer 2 is in particular at least 60%, in particular at least 70%, in particular at least 80%, in particular at least 90%.

A packaging 4 according to the invention also comprises a base film 5. The base film 5 is configured as a mono-film or as a multi-layer composite. The base film 5 comprises, in particular, a material selected from the group of polyvinyl chloride (PVC), cyclic olefin copolymer (COC), polycarbonate (PC) and polyoxymethylene (POM). It consists, in particular, of a material of this type. It may, in particular, be made of the same material as the sealing film 3. It has a thickness in the range from 100 μm to 1000 μm, in particular in the range from 300 μm to 800 μm, in particular in the range from 450 μm to 550 μm. The thickness of the base film 5 is related to the application and can be selected depending on need.

The packaging 4 is provided to package food, pharmaceutical or cosmetic products. It may be configured as a blister packaging.

Because of the UV-permeability of the film 3 and the sealing layer 2, the packaging 4, in particular the sealing layer 2, allows a UV-sterilisation of the packaging content.

What is claimed is:

1. A method for producing a seal lacquer (1) comprising the following steps:
a. providing an organic solvent selected from the group of aliphatic, hydrogenated, cyclic and linear or branched hydrocarbons, ketones and cyclic aliphatic or aromatic ethers,
b. providing at least one sealing means selected from the group of cyclic olefin copolymer (COC) and polycarbonate (PC) and
c. dissolving the at least one sealing means in the solvent to produce a liquid phase.

2. A method according to claim 1, wherein at least two sealing means dissolved in solvent, are added.

3. A method according to claim 1, wherein a plurality of sealing means dissolved in solvent, are added.

4. A seal lacquer (1)
a. which is liquid under normal conditions, and
b. which is at least 50% UV-permeable.

5. A seal lacquer (1) according to claim 4, comprising at least a proportion selected from the group of cyclic olefin copolymer (COC) and polycarbonate (PC).

6. A seal lacquer (1) according to claim 5, comprising a proportion selected from the group of substituted benzenes such as α-methylstyrene, styrene and functional rubbers.

7. A seal lacquer (1) according to claim 5, comprising a proportion selected from the group of substituted benzenes such as styrene-hydrocarbon block copolymers, for example SEBS, SBS, SIBS, SIS.

8. A seal lacquer (1) according to claim 4, wherein it consists of pure COC.

9. A seal lacquer (1) according to claim 5, wherein the COC has boundary groups selected from the group of maleic acid modified hydrocarbon resins.

10. A seal lacquer (1) according to claim 4, wherein it is a heat seal lacquer.

11. A method for producing a sealing layer (2) comprising the following steps:
providing a carrier element (3) to be coated, in particular a plastics material layer,
providing a liquid seal lacquer (1) according to any one of claim 4,
applying the seal lacquer (1) to the carrier element (3),
drying the seal lacquer (1).

12. A method according to claim 11, wherein a sealing window with temperatures in the range from 80° C. to 140° C. is provided to dry the seal lacquer (1).

13. A method according to claim 11, wherein a period in the range from 5 sec to 10 sec under normal pressure is provided to dry the seal lacquer (1).

14. A sealing layer (2) comprising a seal lacquer (1) according to claim 4, comprising an adjustable sealing seam strength.

15. A packaging (4) comprising
a. at least one carrier element (3) and
b. a layer applied thereto comprising a seal lacquer (1) according to claim 4.

16. A packaging (4) according to claim 15, wherein the carrier element is configured as a plastics material film (3).

17. A packaging (4) according to claim 15, wherein the carrier element (3) is UV-transparent.
